(19) United States
(12) Patent Application Publication
(10) Pub. No.: US 2016/0091724 A1
(43) Pub. Date: Mar. 31, 2016

(54) STEREOSCOPIC KALEIDOSCOPE AND PROJECTING DEVICE

(71) Applicant: WON TAY INDUSTRIAL CO., LTD., TAICHUNG CITY (TW)

(72) Inventor: Tung-Kuei CHUNG, TAICHUNG CITY (TW)

(73) Assignee: WON TAY INDUSTRIAL CO., LTD., TAICHUNG CITY (TW)

(21) Appl. No.: 14/858,184

(22) Filed: Sep. 18, 2015

(30) Foreign Application Priority Data
Sep. 25, 2014 (TW) 103217009

(51) Int. Cl. G02B 27/08; G02B 27/22; G02B 26/08

(52) U.S. Cl. CPC G02B 27/08; G02B 26/0816; G02B 27/2235

(57) ABSTRACT

A kaleidoscope has a motor assembly, a reflection assembly, a lighting assembly, a mirror assembly, a lens assembly, and a lens kit. The reflection assembly has a reflection object with a pattern. The reflection object is rotatable and driven by the motor assembly. The lighting assembly has an illuminator. The light of the illuminator radiates to the reflection object. The pattern of the reflection object is reflected by the mirror assembly, and then is projected by the lens assembly and the lens kit to produce a stereogram. The lens assembly and the lens kit cause a phase difference and project the pattern of the reflection object outside of the kaleidoscope to provide a novel and diverse optical experience.

### BACKGROUND OF THE INVENTION

1. Field of the Invention

The present invention relates to a kaleidoscope, and more particularly to a kaleidoscope capable of generating stereogram.

2. Description of Related Art

A conventional kaleidoscope comprises a tube, a colored receptacle, a mirror set, and an ocular. The tube has two ends. The colored receptacle is rotatable and is connected to one of the ends of the tube. The colored receptacle has multiple decoration pieces that are mounted inside the colored receptacle. The mirror set is inserted inside the tube. The ocular is mounted at the other end of the tube. By rotating the colored receptacle, the decoration pieces can be moved irregularly. With illuminating lights, the pattern formed by the decoration pieces is reflected by the mirror set for a user to watch. However, the conventional kaleidoscope has the following problems. First, the variation of the pattern of the conventional kaleidoscope is limited by the decoration pieces and is humdrum. Second, the conventional kaleidoscope can only display the pattern in a bright environment. Finally, a user of the conventional kaleidoscope can only watch the pattern with one eye and easily suffers an eye fatigue.

To overcome the shortcomings of the conventional kaleidoscope, the present invention provides a kaleidoscope to mitigate or obviate the aforementioned problems.

### SUMMARY OF THE INVENTION

The main objective of the present invention is to provide a kaleidoscope capable of generating stereogram.

The kaleidoscope comprises a motor assembly, a reflection assembly, a lighting assembly, a mirror assembly, a lens assembly, and a lens kit. The reflection assembly has a reflection object with a pattern. The reflection object is rotatable and is driven by the motor assembly. The lighting assembly has an illuminator. The light of the illuminator radiates to the reflection object. The pattern of the reflection object is reflected by the mirror assembly, and then is projected by the lens assembly and the lens kit to generate a stereogram. The lens assembly and the lens kit cause a phase difference and project the pattern of the reflection object outside of the kaleidoscope to provide a novel and diverse optical experience.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a kaleidoscope in accordance with the present invention;

FIG. 2 is a partially exploded perspective view of the kaleidoscope in FIG. 1;

FIG. 3 is another partially exploded perspective view of the kaleidoscope in FIG. 1;

FIG. 4 is a side view in partial section of the kaleidoscope in FIG. 1;

FIG. 5 is an operational side view in partial section of an optical path of the kaleidoscope in FIG. 1;

FIG. 6 is an operational top view in partial section of the optical path of the kaleidoscope in FIG. 1;

FIG. 7 is a partially exploded perspective view of a second embodiment of a kaleidoscope in accordance with the present invention; and

FIG. 8 is an operational side view in partial section of an optical path of the kaleidoscope in FIG. 7.

### DETAILED DESCRIPTION OF PREFERRED EMBODIMENT

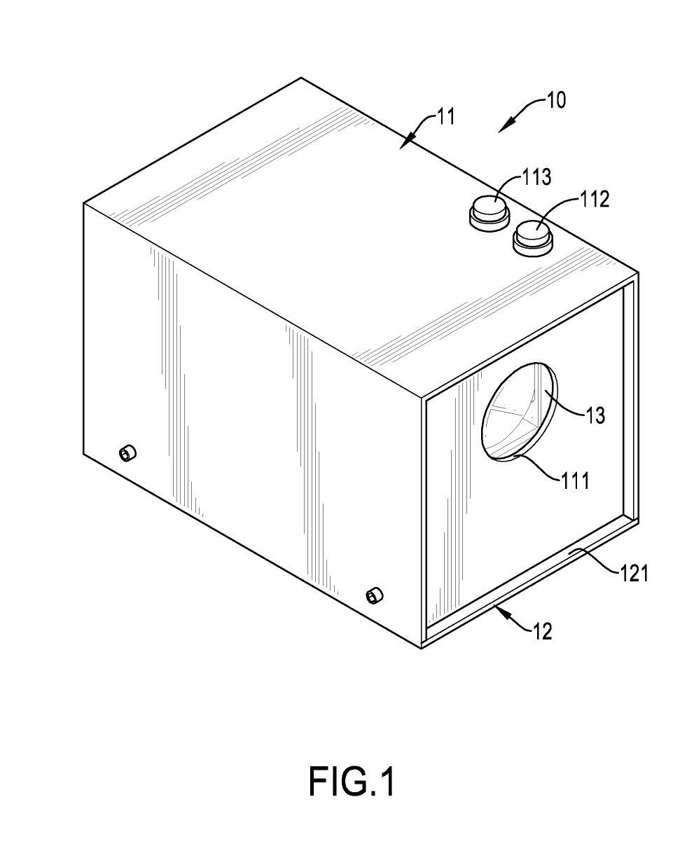

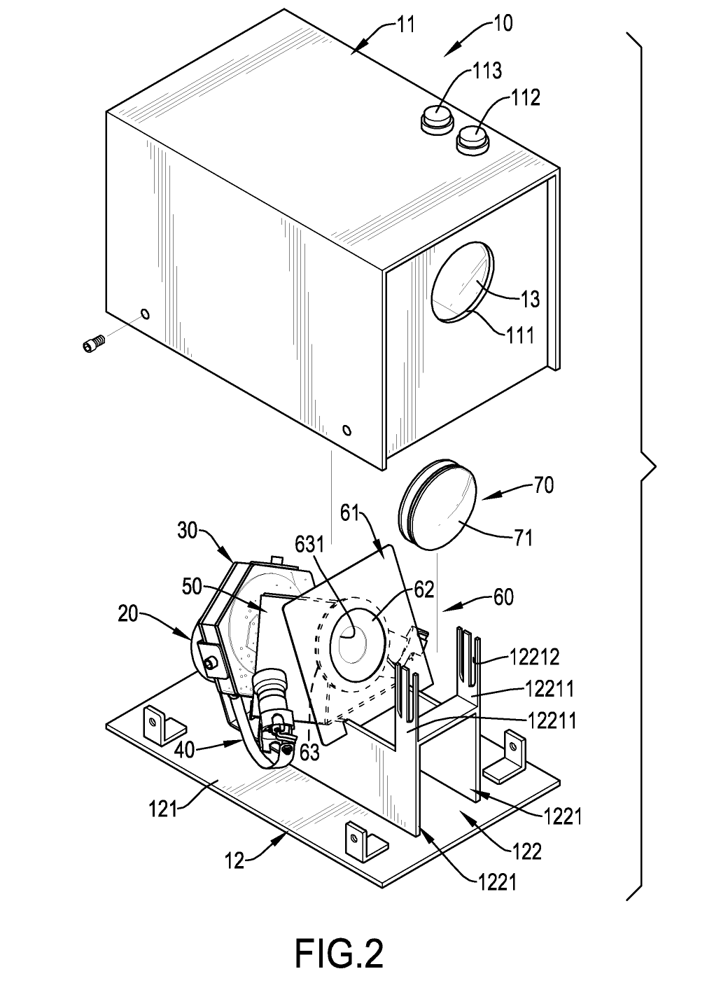

With reference to FIG. 1 and FIG. 2, a kaleidoscope in accordance with the present invention comprises a housing 10, a motor assembly 20, a reflection assembly 30, two lighting assemblies 40, a mirror assembly 50, a lens assembly 60 and a lens kit 70.

With reference to FIG. 1 and FIG. 2, the housing 10 has a case 11, a base 12, and a cover 13. The housing 10 may be polygonal or circular. As showing in FIG. 1, the housing 10 is rectangular. The case 11 has a front end, a rear end, two lateral walls, a viewing hole 111, a bottom, an opening, a power switch 112, and a light switch 113. The two lateral walls are respectively arranged at the front end and the rear end of the case 11. The viewing hole 111 is defined through the lateral wall that is arranged at the front end of the case 11. The opening is arranged at the bottom of the case 11. The power switch 112 and the light switch 113 are assembled on the case 11. The power switch 112 and the light switch 113 are connected with an electrical power source.

With reference to FIGS. 1, 2, and 4, the base 12 is mounted at the bottom of the case 11 and closes the opening of the case 11. The base 12 has a base board 121 and a mount 122. The base board 121 is a flat plate which is arranged in a lateral direction. The mount 122 has two sides and two assembling boards 1221. The two assembling boards 1221 are identical to each other and are oppositely mounted on the base board 121. Each one of the two assembling boards 1221 has two ends, a lens assembling portion 12211, multiple slots 12212, and a mirror assembling portion 12213. The lens assembling portion 12211 is adjacent to the viewing hole 111 and extends upwardly at one of the two ends of the assembling board 1221. The slots 12212 are formed in the lens assembling portion 12211 and are distal from the base board 121. The mirror assembling portion 12213 is inclined and is formed at the other end of the assembling board 1221 opposite the lens assembling portion 12211.

With reference to FIGS. 1, 2, and 4, the cover 13 is a transparent plate. The cover 13 is attached to the lateral wall that has the viewing hole 111 to close the viewing hole 111.

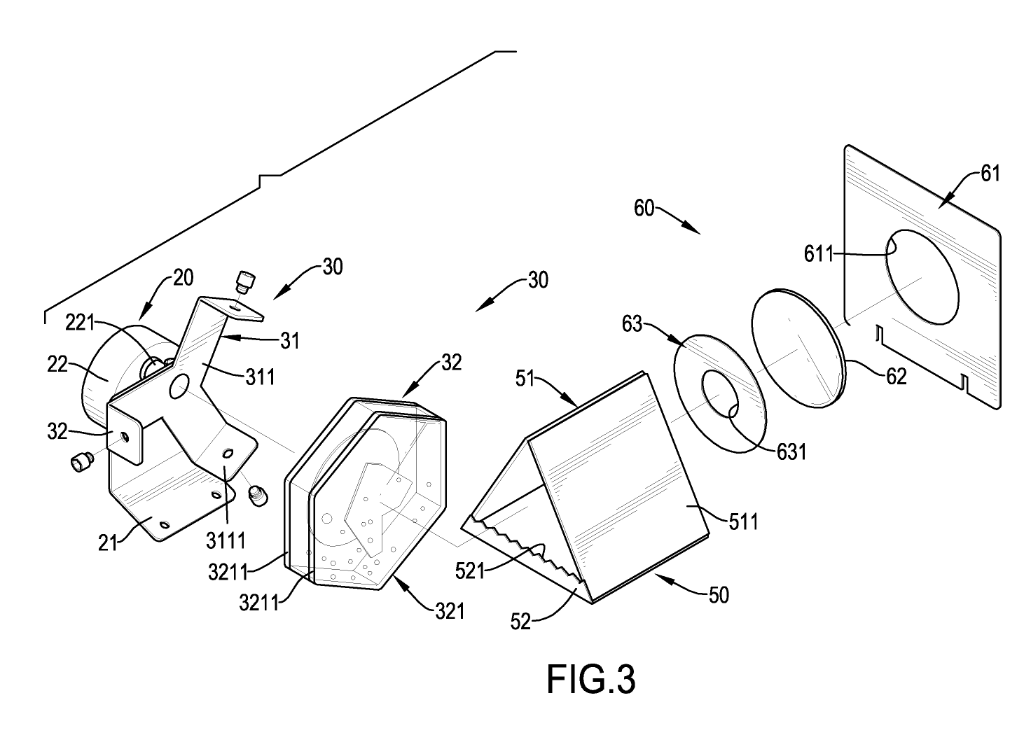

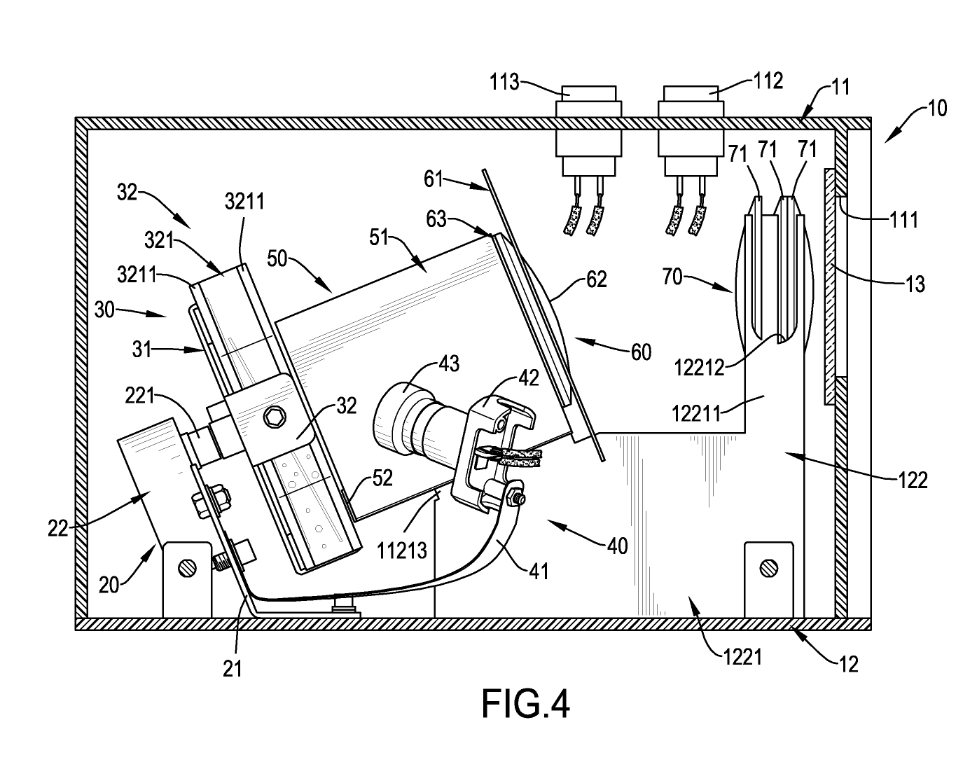

With reference to FIG. 3 and FIG. 4, the motor assembly 20 is mounted in the housing 10 at a position behind the mount 122 and is distal from the viewing hole 111. The motor assembly 20 has an assembling frame 21 and a motor 22. The assembling frame 21 is bended at an obtuse angle and has two ends. One end of the assembling frame 21 is attached to the base board 121. The motor 22 is obliquely fixed at the other end of the assembling frame 21 and has a rotatable driving shaft 221. The motor 22 is electrically connected with the power switch 112.

With reference to FIG. 3, the reflection assembly 30 is assembled inside the housing 10. The reflection assembly 30 has a fixing frame 31 and a reflection object 32. The fixing frame 31 has a center and multiple branches 311. The center of the fixing frame 31 is mounted securely around the driving shaft 221. The branches 311 are radially formed around the center of the fixing frame 31. Each one of the branches 311 has a free end and a fixing portion 3111. The free end of each branch 311 is away from the center of the fixing frame 31. The fixing portion 3111 of each branch 311 is bended and is formed at the free end of the branch 311.

With reference to FIG. 3, the reflection object 32 is rotatable and is driven by the motor 22. The reflection object 32 may be a colored plate with colorful pattern. The reflection object 32 has a reflecting surface and a receptacle 321. The reflection object 32 may be polygonal or circular. As showing in FIG. 3, the reflection object 32 is hexagonal. The reflecting face faces to the mount 122. The receptacle 321 has two opposite sides and is filled with multiple kinds of solutions (such as oil or water), multiple decoration pieces, and multiple pellets. The solutions, the decoration pieces, and the pellets have different colors for the reflection object 32 to display different colors and patterns. The receptacle 321 may further have two boxes 3211. The two boxes 3211 are respectively arranged on the two opposite sides of the receptacle 321. Each box 3211 may also be filled with solutions, decoration pieces, and pellets respectively.

With reference to FIGS. 4, 5, and 6, the two lighting assemblies 40 are assembled inside the housing 10. The two lighting assemblies 40 are same as each other in structure and are respectively arranged on the two sides of the mount 122. Each lighting assembly 40 has a supporting frame 41, an assembling seat 42, and an illuminator 43. The supporting frame 41 is flexible and has two opposite ends. One of the two ends of the supporting frame 41 is fixed on the assembling frame 21. The assembling seat 42 is fixed at the other end of the supporting frame 41. The illuminator 43 is assembled on the assembling seat 42. Each illuminator 43 faces to the reflection assembly 30 and is electrically connected with the light switch 113. Each illuminator 43 can emit light toward the reflecting surface of the reflection object 32. Since the supporting frame 41 is flexible, the illuminator 43 can be adjusted to a suitable angle for emission. The supporting frame 41 may be fixed on the case 11 and the base 12 for a suitable illumination position. The illuminators 43 may be light emitting diodes or laser lights.

With reference to FIG. 1 and FIG. 2, the mirror assembly 50 is assembled inside the housing 10 and is in front of the reflection assembly 30. The mirror assembly 50 has a mirror set 51 and a blocking board 52. The mirror set 51 is mounted on the mirror assembling portions 12213 of the two assembling boards 1221 of the mount 122. The mirror set 51 has three mirrors 511 and two opposite ends. Each mirror 511 has a reflecting face. The three mirrors 511 are joined together to form a triangle. The reflecting face of each mirror 511 faces inward. One of the two ends of the mirror set 51 faces to the viewing hole 111 of the case 11. The other end of the mirror set 51 faces to the reflection object 32 of the reflection assembly 30. The mirror set 51 may be formed as a rectangle, trapezoid, or any other polygon.

The blocking board 52 is connected at one end of the mirror set 51 and is adjacent to the reflection object 32 of the reflection assembly 30. The blocking board 52 has two opposite sides and an edge 521. The edge 521 is formed on one side of the blocking board 52 and may be wavy or jagged. The edge 521 faces inward into the mirror set 51. The blocking board 52 partially blocks the reflection object 32 and produces a phase difference.

With reference to FIG. 3 and FIG. 4, the lens assembly 60 is assembled inside the housing 10 and is arranged in front of the mirror assembly 50. The lens assembly 60 has a lens frame 61, a lens 62, and a blocking sheet 63. The lens frame 61 is assembled on the mount 122 and has a rectangular plate and a circular hole 611. The circular hole 611 is defined through the rectangular plate. The lens 62 is a plano-convex lens and has a flat surface and a convex surface. The flat surface and the convex surface of the lens 62 are opposite each other. The lens 62 is mounted in the circular hole 611 of the lens frame 61 and the flat surface of the lens 62 faces to the mirror assembly 50. The lens 62 is partially covered by the lens frame 61 to make the projection of the reflection object 32 evenly pass through the lens 62. The lens 62 may be constructed by two hollow and transparent acrylic plates, and a transparent liquid is filled between the two acrylic plates. The blocking sheet 63 is attached to the flat surface of the lens 62 and has an opaque plate and a through hole 631. The through hole 631 is defined through the opaque plate. The through hole 631 allows the light reflected by the reflecting surface to pass through the through hole 631. A distance is defined between the blocking sheet 63 and the reflection object 32.

With reference to FIGS. 2, 3, and 4, the lens kit 70 is assembled inside the housing 10 and is in front of the lens assembly 60. The lens kit 70 is mounted on the lens assembling portions 12211 of the two assembling boards 1221 of the mount 122. The lens kit 70 has three lenses 71. Each lens 71 is a plano-convex lens and has a flat surface and a convex surface. The flat surface and the convex surface of each lens 71 are opposite each other. One of the lenses 71 is inserted into one of the slots 12212 and is adjacent to the lens assembly 60; the convex surface of said one of the lenses 71 faces to the lens assembly 60. The other two lenses 71 are attached to each other with the flat surfaces of the two lenses 71 and are inserted into the other slot 12212 and are adjacent to the viewing hole 111. The types and number of the lens 71 may be varied based on the requirements of the stereogram. The types, the number, the arranged pattern, and the focus of the lens 73 can be adjusted to acquire an optimum stereogram.

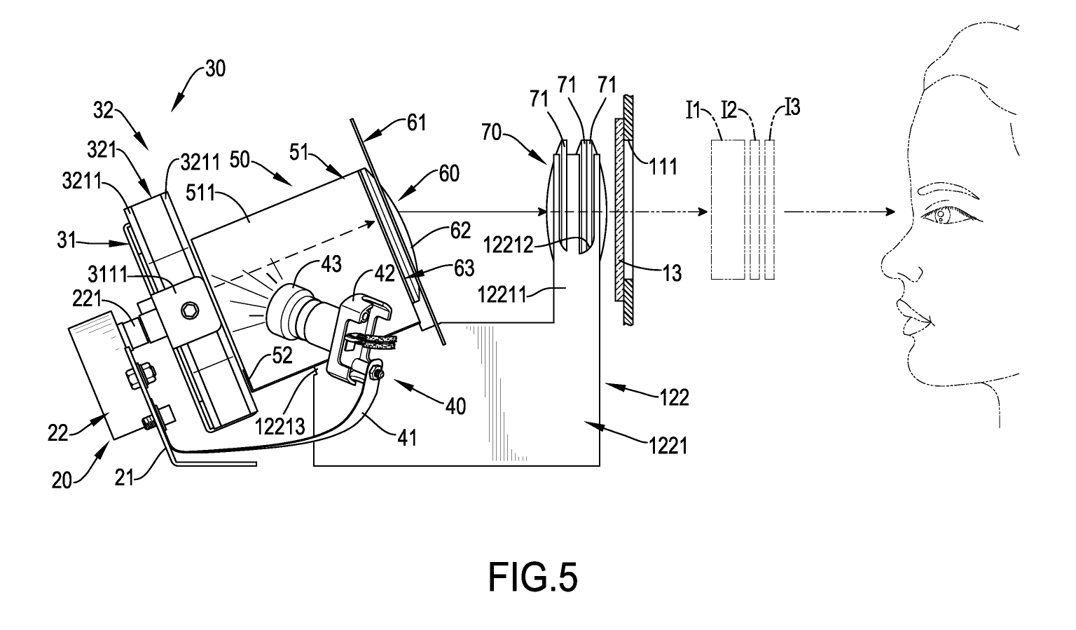

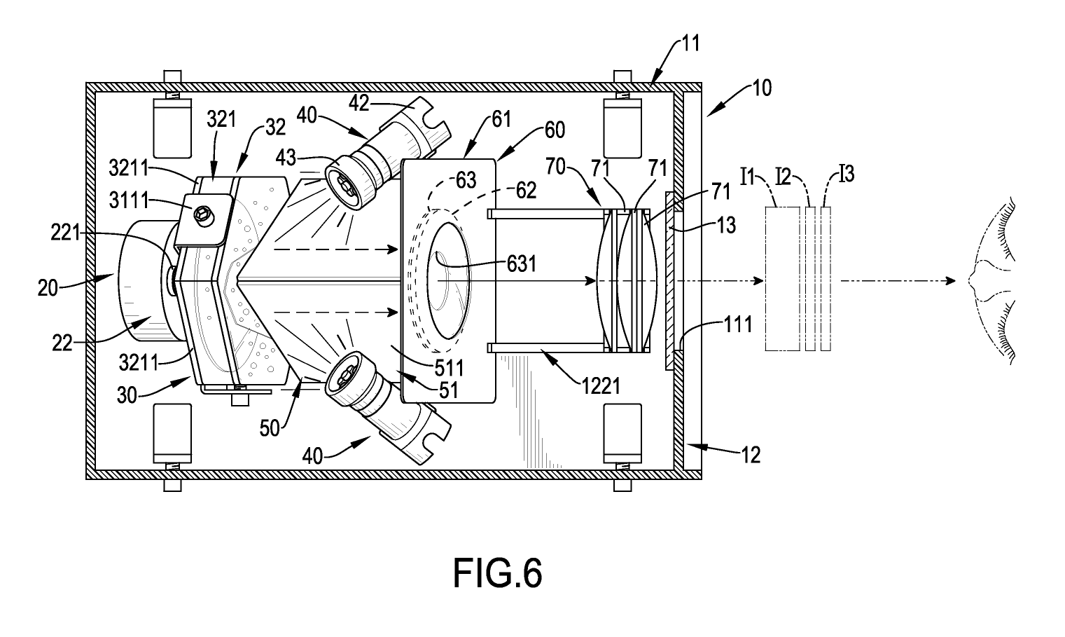

With reference to FIG. 5 and FIG. 6, the reflection object 32 spins and is driven by the motor 22 of the motor assembly 20. The light of the two illuminators 43 is emitted toward the reflecting surface. The solution, the decoration pieces, and the pellets that are held in the receptacle 321 form various patterns when the receptacle 321 spins. The patterns are reflected by the mirror set 51 and are projected by the lens assembly 60 and the lens kit 70 to form a stereogram I1 which is outside of the housing 10. A stereogram I2 is formed outside of the housing 10 by the phase difference which is generated by the blocking board 52. A stereogram I3 is formed outside of the housing 10 by the distance which is defined between blocking sheet 63 and the reflection object 32. A user of the kaleidoscope can stand away from the housing 10 and can view the stereograms I1 to I3 that are outside of the housing 10 by bare eyes. The kaleidoscope in accordance with the present invention can overcome the shortcomings of conventional kaleidoscope and can provide much more vivid vision than the vision that is provided by the conventional kaleidoscope.

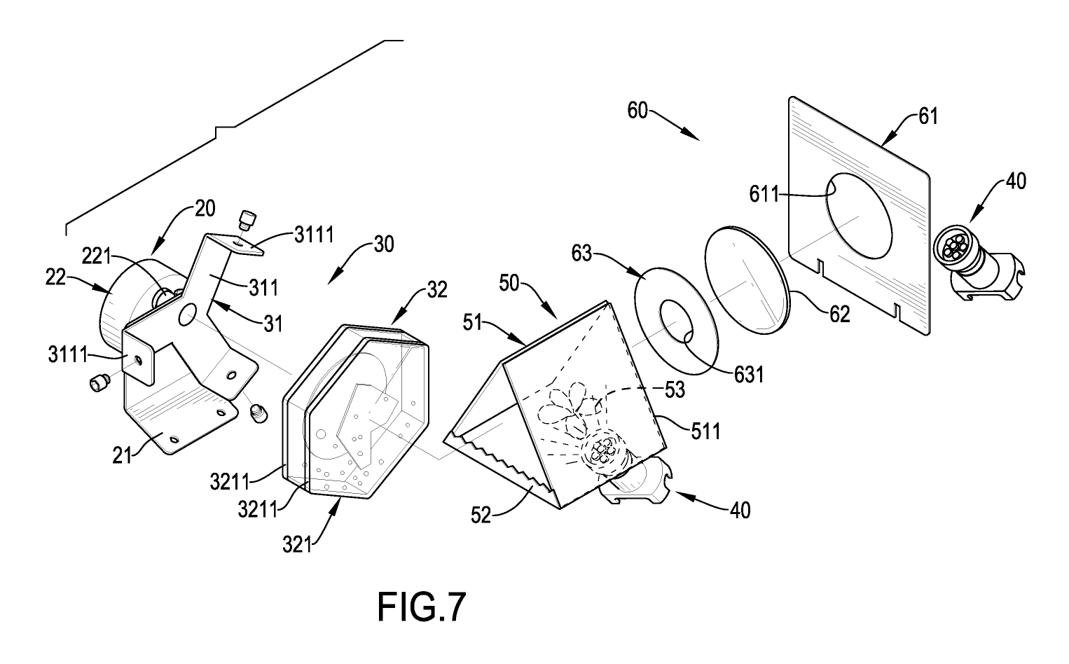

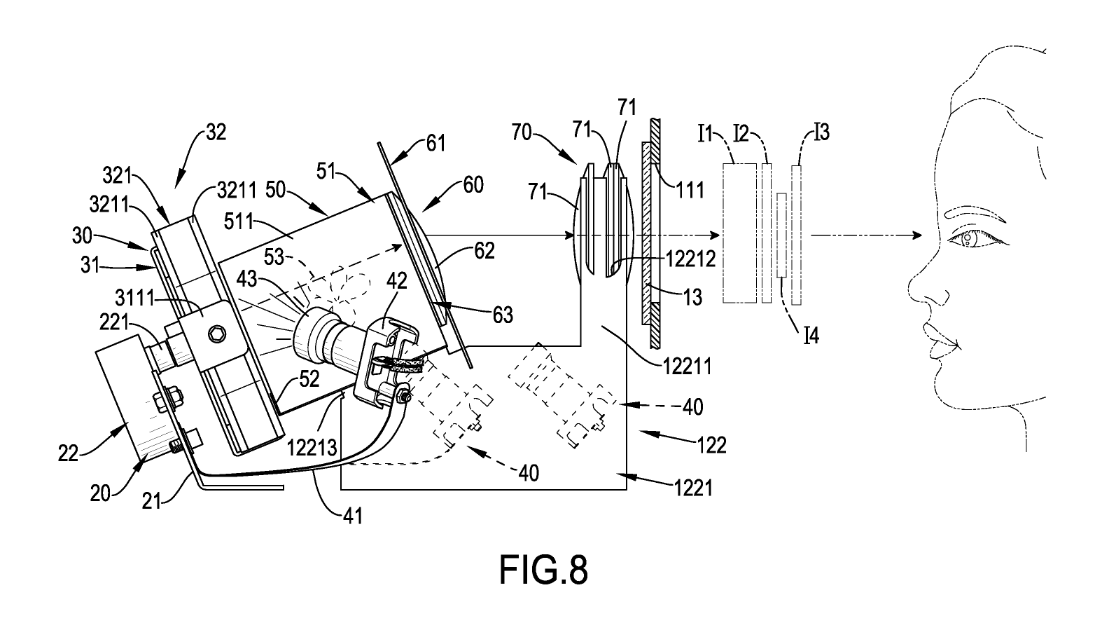

With reference to FIG. 7 and FIG. 8, in the second embodiment, two additional lighting assemblies 40 are respectively arranged beneath the mirror set 51 and the lens kit 70. The mirror set 51 has two mirrors 511. The two mirrors 511 are joined together to form an inverted V shape. The mirror assembly 50 further has a decoration 53 which is arranged inside the mirror set 51. The decoration 53 may be a floral decoration. A stereogram I4 is formed outside of the housing 10 to add variety of the vision which is provided by the kaleidoscope in accordance with the present invention.

When the kaleidoscope in accordance with the present invention is enlarged in size, the lens 62 of the lens assembly 60 and the lens 71 of the lens kit 70 must also be enlarged in size accordingly. A larger lens takes a lot of materials, raises production cost, and is difficult to manufacture. The present invention also provides the lens 61 that is constructed by two hollow and transparent acrylic plates and a transparent liquid filled between the two acrylic plates, thereby reducing the cost and the difficulties of lens production.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A kaleidoscope comprising:
a housing having
a case having a front end and a viewing hole formed at the front end of the case;
a base mounted on the case; and
a motor assembly assembled inside the housing and being distal from the viewing hole, the motor assembly having a motor;
a reflection assembly assembled inside the housing and having a rotatable reflection object, the reflection object connected to and driven by the motor;
a lighting assembly assembled inside the housing and having an illuminator facing to the reflection object;
a mirror assembly assembled inside the housing and being in front of the reflection assembly;
a lens assembly assembled inside the housing and being in front of the mirror assembly, the lens assembly having a lens; and
a lens kit assembled inside the housing and being in front of the lens assembly, the lens kit having multiple lenses.

2. The kaleidoscope as claimed in claim 1, wherein
the lenses of the lens kit are implemented as three in amount and each lens of the lens kit has a flat surface and a convex surface, the flat surface and the convex surface of each lens of the lens kit are opposite to each other;
one of the lenses of the lens kit is adjacent to the lens assembly and the convex surface of said lens faces to the lens assembly; and
the other two lenses of the lens kit are attached to each other with the flat surfaces of the two lenses and are adjacent to the viewing hole.

3. The kaleidoscope as claimed in claim 2 further comprising one more lighting assembly, wherein the two lighting assemblies are respectively arranged on two sides of the mirror assembly and each lighting assembly has
a supporting frame having two opposite ends;
an assembling seat fixed at one end of the supporting frame; and
the illuminator assembled on the assembling seat and facing to the reflection assembly.

4. The kaleidoscope as claimed in claim 3, wherein
the base has a mount;
the mirror assembly is assembled on the mount and has a mirror set and a blocking board;
the mirror set has three mirrors and two opposite ends;
each mirror has a reflecting face, the three mirrors are joined together to form a triangle, and the reflecting face of each mirror faces inwards;
one of the two ends of the mirror set faces to the reflection object;
the blocking board is connected at one of the ends of the mirror set and is adjacent to the reflection object, and the blocking board has two opposite sides and an edge; and
the edge is formed on one of the sides of the blocking board and is wavy.

5. The kaleidoscope as claimed in claim 3, further comprising two additional lighting assemblies that are respectively arranged beneath the mirror assembly and the lens kit;
the base has a mount;
the mirror assembly is assembled on the mount and has
a mirror set having two mirrors and two opposite ends;
each mirror has a reflecting face;
the two mirrors are joined together to form an inverted V shape; the reflecting face of each mirror faces inwards;
one of the two ends of the mirror set faces to the reflection object;
a blocking board is connected at one of the ends of the mirror set and is adjacent to the reflection object;
the blocking board has two opposite sides and an edge;
the edge is formed on one of the sides of the blocking board and is wavy; and
a decoration is arranged inside the mirror set.

6. The kaleidoscope as claimed in claim 4, wherein the lens assembly has
a lens frame assembled on the mount;
the lens of the lens assembly mounted on the lens frame and having a flat surface and a convex surface, the flat surface and the convex surface of the lens of the lens assembly being opposite each other, and the flat surface of the lens of the lens assembly facing to the mirror assembly; and
a blocking sheet attached to the flat surface of the lens of the lens assembly, and the blocking sheet having an opaque plate and a through hole defined through the opaque plate.

7. The kaleidoscope as claimed in claim 5, wherein the lens assembly has
a lens frame assembled on the mount;
the lens of the lens assembly mounted on the lens frame and having a flat surface and a convex surface, the flat surface and the convex surface of the lens of the lens assembly being opposite each other, and the flat surface of the lens of the lens assembly facing to the mirror assembly; and
a blocking sheet attached to the flat surface of the lens of the lens assembly, and the blocking sheet having an opaque plate and a through hole defined through the opaque plate.

8. A projecting device comprising:
a reflection assembly having a rotatable reflection object;
a lighting assembly having an illuminator facing to the reflection object;
a mirror assembly being in front of the reflection assembly;
a lens assembly being in front of the mirror assembly, the lens assembly having a lens;
a lens kit being in front of the lens assembly, the lens kit having multiple lenses.

9. The projecting device as claimed in claim 8, wherein
the lenses of the lens kit are implemented as three in amount and each lens of the lens kit has a flat surface and a convex surface, the flat surface and the convex surface of each lens of the lens kit are opposite each other;
one of the lenses of the lens kit is adjacent to the lens assembly and the convex surface of said lens of the lens kit is faced to the lens assembly; and
the other two lenses of the lens kit are attached to each other with the flat surfaces of the two lenses and are adjacent to the viewing hole.

10. The projecting device as claimed in claim 9 further comprising one more lighting assembly, wherein the two lighting assemblies are respectively arranged on two sides of the mirror assembly and each lighting assembly has
a supporting frame having two opposite ends;
an assembling seat fixed at one end of the supporting frame; and
the illuminator assembled on the assembling seat and facing to the reflection assembly.

11. The projecting device as claimed in claim 10, wherein
the mirror assembly has a mirror set and a blocking board;
the mirror set has three mirrors and two opposite ends;
each mirror has a reflecting face, the three mirrors are joined together to form a triangle, and the reflecting face of each mirror faces inwards;
one of the two ends of the mirror set faces to the reflection object;
the blocking board is connected at one of the ends of the mirror set and is adjacent to the reflection object, and the blocking board has two opposite sides and an edge; and
the edge is formed on one of the sides of the blocking board and is wavy.

12. The projecting device as claimed in claim 10 further comprising two additional lighting assemblies that are respectively arranged beneath the mirror assembly and the lens kit;
the mirror assembly has a mirror set having two mirrors and two opposite ends;
each mirror has a reflecting face;
the two mirrors are joined together to form an inverted V shape; the reflecting face of each mirror faces inwards;
one of the two ends of the mirror set faces to the reflection object;
a blocking board is connected at one of the ends of the mirror set and is adjacent to the reflection object;
the blocking board has two opposite sides and an edge;
the edge is formed on one of the sides of the blocking board and is wavy; and
a decoration is arranged inside of the mirror set.

13. The projecting device as claimed in claim 11, wherein the lens assembly has
a lens frame;
the lens of the lens assembly mounted on the lens frame and having a flat surface and a convex surface, the flat surface and the convex surface of the lens of the lens assembly being opposite to each other, and the flat surface of the lens of the lens assembly facing to the mirror assembly; and
a blocking sheet attached to the flat surface of the lens of the lens assembly, and the blocking sheet having an opaque plate and a through hole defined through the opaque plate.

14. The projecting device as claimed in claim 12, wherein the lens assembly has
a lens frame;
the lens mounted on the lens frame and having a flat surface and a convex surface, the flat surface and the convex surface of the lens of the lens assembly being opposite to each other, and the flat surface of the lens of the lens assembly facing to the mirror assembly; and
a blocking sheet attached to the flat surface of the lens of the lens assembly, and the blocking sheet having an opaque plate and a through hole defined through the opaque plate.
